(19) United States
(12) Patent Application Publication
(10) Pub. No.: US 2007/0150512 A1
(43) Pub. Date: Jun. 28, 2007

(54) Collaborative meeting assistant

(75) Inventors: Yuan Kong, Kirkland, WA (US); David W. Williams, Woodinville, WA (US); David J. Kurlander, Seattle, WA (US); Behrooz Chitsaz, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/300,916

(22) Filed: Dec. 15, 2005

(51) Int. Cl. G06F 17/00

(52) U.S. Cl. 707/104.1

(57) ABSTRACT

A data collaboration system that aggregates data from a number of multi-modal mobile devices in connection with collaborative note taking, presentation generation, memorializing a meeting, etc. The data collaboration system can automatically compile, index and/or memorialize data from numerous multi-modal multi-lingual mobile devices. More particularly, the system can filter and aggregate information from a plurality of disparate multi-modal devices. The system can facilitate indexing information gathered from a group of multi-modal mobile devices. The indexing can be based upon any desired criteria including but not limited to information type, importance, etc.

### BACKGROUND

Both enterprises and individuals are increasingly interested in using handheld devices. Most modem handheld devices are equipped with multiple sensors (e.g., microphone, wireless transmitter, global positioning system (GPS) engine, camera, stylus, etc.). However, there are no applications available that make full use of these multiple sensors. In other words, multi-sensory technologies that make handheld devices a multi-modal multi-lingual mobile assistant are not available.

Today, cellular telephones running on state-of-the-art operating systems have increased computing power in hardware and increased features in software in relation to earlier technologies. For instance, cellular telephones are often equipped with built-in digital image capture devices (e.g., cameras) and microphones together with computing functionalities of personal digital assistants (PDAs). Since these devices combine the functionality of cellular phones with the functionality of PDAs, they are commonly referred to as “smart-phones.”

The hardware and software features available in these smart-phones and similar technologically capable devices provide developers the capability and flexibility to build applications through a versatile platform. The increasing market penetration of these portable devices (e.g., PDAs) inspires programmers to build applications, Internet browsers, etc. for these portable devices.

As stated above, many smart-phones have built-in digital cameras capable of generating video graphics array (VGA) quality images having 640×480 pixel resolutions. As well, many of these devices are capable of capturing video streams in addition to still images. Today, cameras integral to cell phones can routinely capture images in a 2 megapixel resolution range. Moreover, cell phones are available with image capture devices capable of 7 megapixel resolution.

Due to the ongoing technological rise in camera phones, many consumers are purchasing camera phones in lieu of digital cameras. As technology evolves, these camera phones may soon replace the video recorder as well. Megapixel camera phones have a significant role in today's society as a network connected device. For example, these megapixel camera phones are frequently used in positive aspects of society such as communication, journalism and crime prevention.

However, oftentimes these camera phones are prone to abuse such as voyeurism and invasion of privacy. As such, some organizations and places have started to ban camera phones because of the privacy and security issues they raise. Recently, videophones have emerged which enable transmission of video streams and video calls. For example, these videophones have become prevalent in capturing footage used by news organizations.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a data collaboration system that can aggregate a number of multi-modal mobile devices in connection with collaborative note taking, presentation generation, memorializing a meeting, etc. In a more specific example, the innovation comprises a data collaboration system that can compile, index and/or memorialize data from numerous multi-modal multi-lingual mobile devices. In one aspect, the system can filter and thereafter aggregate information from a plurality of disparate multi-modal devices. Another aspect can facilitate indexing information gathered from a group of multi-modal mobile devices. The indexing can be based upon any desired criteria including but not limited to information type, importance, etc.

In another example, a group of multi-modal devices can be placed around a conference table thus facilitating generation of a dynamic ring camera. This dynamic ring camera can be effectuated via a collaboration component that interrogates and controls operation of cameras integral to the disparate multi-modal devices.

In other words, an aspect can employ a collaboration component that facilitates a role of a producer thereby controlling activation and/or deactivation of sensors (e.g., image capture, microphone) based upon a determined context or situational-awareness. These sensors can be employed to automatically detect implementation criteria thereby enabling the devices to intelligently collaborate in accordance with the context. In accordance therewith, an analyzer component can intelligently evaluate criterion and factors (e.g., context) that are compiled and/or received in order to automatically prompt a collaborative data collection and organization system.

Another aspect is directed to a system whereby each multi-modal device includes an integral collaboration component. These integral collaboration components can facilitate each of the multi-modal devices to take on a unique role as part of a combined collaborative documentation effort. By way of example, one device can serve to index information from other devices, another device can memorialize comments/moments while still other devices can perform as data gathering devices and metadata generation devices.

Still another device can assume a role to automatically memorialize (e.g., create a record or journal) data retrieved from a group of multi-modal mobile devices. The memorialization can be based upon any number of factors including but, not limited to, audience type, data type, importance, etc.

In other aspects, the system and/or multi-modal multi-lingual mobile device can employ artificial intelligence (AI) reasoning/learning techniques and rules-based logic techniques to facilitate collaborative data collection and management. In a particular AI aspect, the system can employ a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates automatically collaborating data in accordance with an aspect of the innovation.

FIG. 2 illustrates a block diagram of a system that employs an analysis component that facilitates analyzing gathered data in accordance with an aspect of the novel innovation.

FIG. 3 illustrates an exemplary flow chart of procedures that facilitate data collaboration in accordance with an aspect of the novel subject matter.

FIG. 4 illustrates a block diagram of a data collaboration system that employs cameras and microphones to gather data in accordance with an aspect of the innovation.

FIG. 5 is a schematic block diagram of a collaboration component having a variety data/sensor management components in accordance with one aspect of the subject innovation.

FIG. 6 illustrates a system that employs a central collaboration component to manage data in accordance with an aspect of the innovation.

FIG. 7 illustrates a system that employs collaboration components integral to multi-modal devices and capable of managing data in accordance with an aspect of the innovation.

FIG. 8 illustrates a graphical representation of a business meeting scenario in accordance with and aspect of the novel data collection and managing system.

FIG. 9 illustrates an architecture of a multi-modal portable communication device that facilitates data collaboration in accordance with an aspect of the innovation.

FIG. 10 illustrates an architecture of a portable handheld device including an artificial intelligence reasoning component that can automate functionality in accordance with an aspect of the innovation.

FIG. 11 illustrates an architecture of a portable handheld device including a rules-based logic component that can automate functionality in accordance with an aspect of the innovation.

FIG. 12 illustrates a block diagram of a computer operable to execute the disclosed architecture.

FIG. 13 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

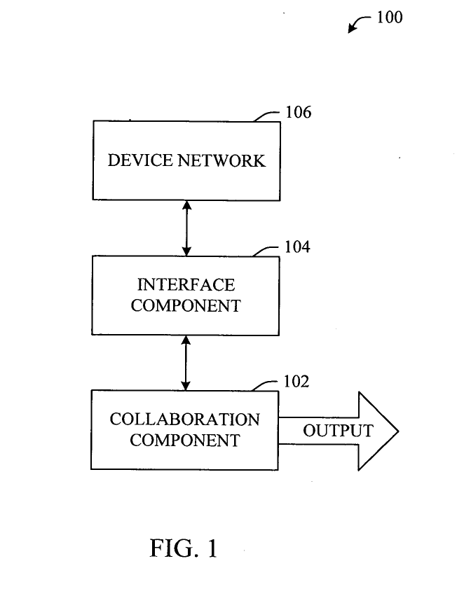

Referring initially to the drawings, FIG. 1 illustrates a system 100 that facilitates collaboration of multi-modal devices. Generally, system 100 can include a collaboration component 102 and an interface component 106 that facilitates a device network 106 to communicate with the collaboration component 102. Although the interface component 104 is illustrated in FIG. 1 external from collaboration component 102, it is to be appreciated that all or a subset of the functionality of each component can be combined into a single component.

It is further to be appreciated that either or both of the collaboration component 102 and/or the interface component 104 can be combined into a multi-modal device (not shown). In this alternative configuration, it will be appreciated that the multi-modal device that includes this functionality can act as a “master” whereby the other multi-modal devices contained within the device network 106 can be “slaves” to the “master.” In other words, it will be appreciated that this “master” device can control aggregation and/or disaggregation of services associated to each “slave” device. This alternative configuration will be better understood upon a review of the figures that follow.

In operation, the collaboration component 104 can receive and aggregate information (e.g., data) from the device network 106 via the interface component 104. For example, in one aspect, the collaboration component 102 can collaborate information from multiple multi-modal devices thereby facilitating a collaborative note taking environment. In another exemplary aspect, the collaboration component 102 can facilitate extracting highlights from aggregated data thereafter generating a presentation that includes the highlights compiled from disparate multi-modal devices.

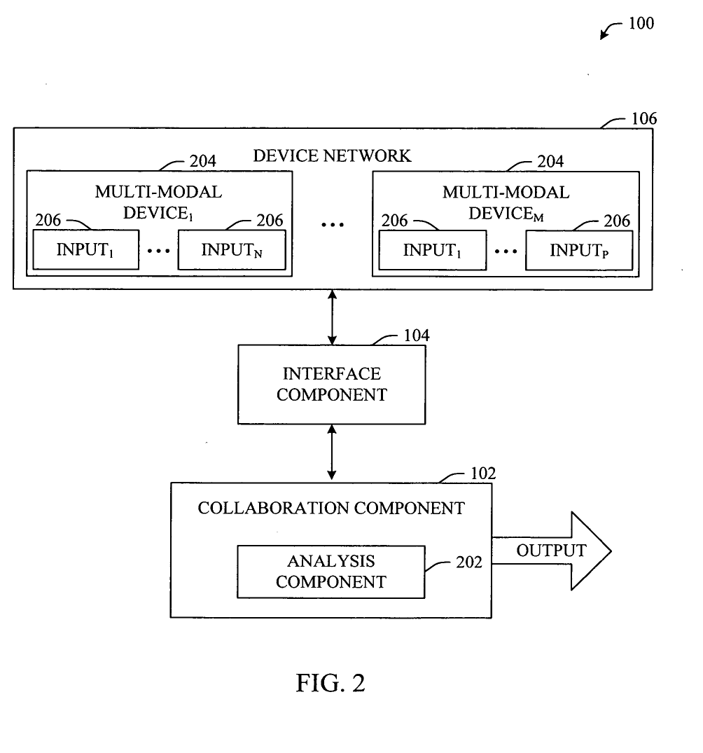

Turning now to FIG. 2, an alternative block diagram of system 100 is shown. More particularly, FIG. 2 illustrates an analyzer component 202 integral to the collaboration component 102. As well, FIG. 2 illustrates that the device network 106 can include 1 to M multi-modal devices, where M is an integer. It is to be understood that 1 to M multi-modal devices can be referred to individually or collectively as multi-modal devices 204.

As illustrated, each multi-modal device 204 can include one or more input components. For example, a first multi-modal device 204 can include 1 to N inputs where a second multi-modal device 204 can include 1 to P inputs, where N and P are integers. In either instance, it is to be understood that 1 to N and 1 to P inputs can be referred to collectively or individually as inputs 206.

Each multi-modal device 204 can include any number of inputs 206 that facilitate capturing and/or generating data. It will be appreciated that the inputs 206 can include, but are not limited to include, an image capture device, a microphone, a keyboard, a touchpad, sensor, global position system (GPS) engine or the like. The analyzer component 202 can retrieve the data via the interface component thereafter performing analysis upon the data.

Generally, the analysis component 202 can determine a context or situational environment based at least in part upon the data received from the inputs 206. For example, the analysis component 206 can determine a context based upon any single input or combination of inputs. By way of more specific example, in an aspect, the system 100 can employ a GPS system (e.g., GPS input 206) to determine a location of the device 204. Once determined, the system 100, via the analysis component 202, can initiate an appropriate action.

In one aspect, suppose it is determined via GPS input, that a device 204 is located at an office location. In this scenario, the collaboration component 102 can automatically initiate a collaborative note taking action in coordination with other multi-modal devices 204 within a transmission range. As such, the inputs 206 of the respective multi-modal devices 204 can capture data and thereafter forward the data to the collaboration component 102.

Although the above example employs an input (e.g., GPS) to determine a specific context, it is to be appreciated that other mechanisms can be employed to determine a context. In another example, a user can directly input the context as desired. In still another aspect, the analysis component 202 can interrogate personal information manager (PIM) data to assist in establishing the context. For example, the analysis component 202 can reference a schedule entry to assist in determining a specific context. By way of further example, if a schedule entry indicates attendance in a business meeting, the analysis component 202 can determine the context based at least in part upon this entry.

Continuing with the example, the collaboration component 102, via the analysis component 202 can analyze the data and thereafter prompt automated actions (e.g., indexing, journalizing) based upon the content and/or characteristics of the data. For example, in the case of textual data, the analysis component 202 can perform a keyword search thereby establishing a context or situational criteria.

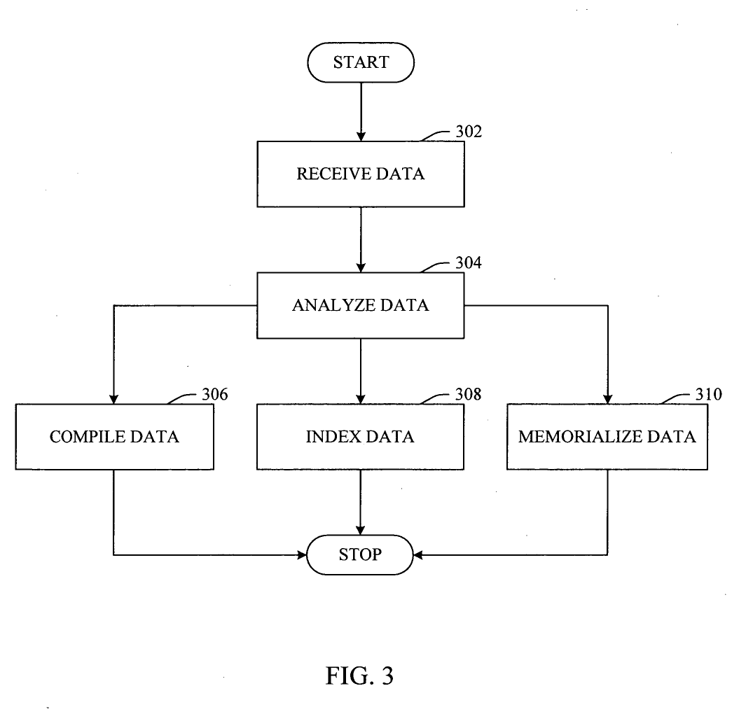

FIG. 3 illustrates a methodology of performing an automated action based at least in part upon a context in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 302, data is received from any of a number of inputs such as a keyboard, microphone, image capture device, sensor or the like. The received data can be analyzed at 304. For example, an analysis component (202 from FIG. 2) can be employed to establish a context from the received data. As well, based upon the established context, the data can be compiled, indexed or memorialized at 306, 308 and 310 respectively.

By way of example, based upon that analysis at 304, the context can determine if the data is to be compiled (e.g., at 306), indexed (e.g., at 308) or memorialized (e.g., at 310). It is to be appreciated that other actions can be performed based upon a determined context. These additional aspects are to be included within the scope of the disclosure and claims appended hereto.

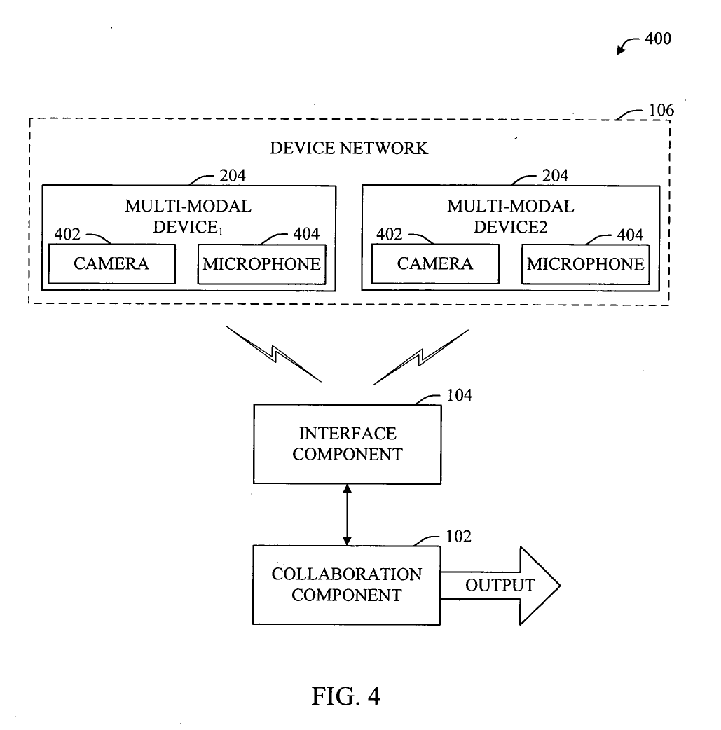

Turning now to FIG. 4, a system 400 that facilitates collaboration of data received from a device network 106 is shown. Generally, system 400 can include a collaboration component 102 and an interface component 104 that facilitates communication between the collaboration component 102 and the device network 106. The device network 106 can include two multi-modal devices 204 as shown.

Continuing with the example of FIG. 4, each multi-modal device can include a camera 402 and a microphone 404. The camera 402 and microphone 404 can facilitate capture of visual and audio data respectively. Once captured, this data can be transmitted, via any wired and/or wireless technique, to the interface component 104 and ultimately to the collaboration component 102. As described above, the collaboration component 104 can analyze the data to determine specific contextual factors surrounding or relating to the data.

For example, the collaboration component 102 can determine, based upon speech recognition tools, an identity of an individual in proximity. Similarly, facial recognition can be employed in accordance with the camera component 402. Once an identity is determined, this information can be analyzed together with the content (e.g., keyword search) of a conversation to more specifically determine a context. Once the context is determined, an automated action can be performed upon the data or subset thereof.

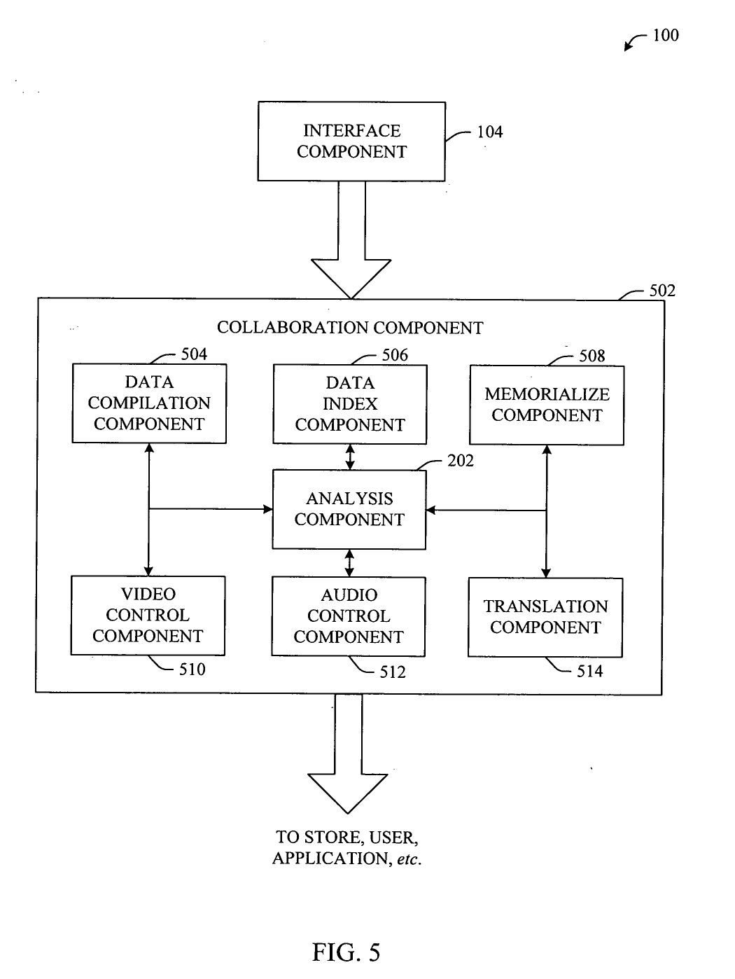

FIG. 5 illustrates a detailed block diagram of an exemplary collaboration component 502 in accordance with an aspect of the innovation. More particularly, the collaboration component 502 in the aspect of FIG. 5 can include an analysis component 202, a data compilation component 504, a data index component 506, a memorialize component 508, a video control component 510, an audio control component 512 and a translation component 514.

Each of the components shown in FIG. 5 will be discussed below with reference to a business meeting scenario. While the scenarios that follow are directed to a business meeting scenario, it is to be understood and appreciated that the novel functionality of aggregating, collaborating, organizing and managing data from a number of disparate multi-modal devices can be employed in countless other scenarios. These additional scenarios are to be included within the scope of this disclosure and claims appended hereto. In other words, the business meeting scenarios that follow are provided to add perspective to the invention and are not intended to limit the invention in any way. The novel functionality of collaborating multi-modal devices can be applied to any scenario without departing from the spirit and scope provided herein.

Referring first to the data compilation component 504, this component can compile the data received from a number of multi-modal mobile devices. In one aspect, the data compilation component 504 can aggregate all of the data without any specific reorganization and/or filtering. In another aspect, the data compilation component 504 can filter a subset of the data and/or organize the data based upon a desired method.

For example, in a business meeting scenario, if desired, the data compilation component 504 can be configured to aggregate only selected recordings and/or data to facilitate a collaborative note taking experience. This collaborative note taking experience can include data from all or a subset of the multi-modal devices in the device network (e.g., 106 of FIG. 1). In other words, the analysis component 202 can be employed to select specific data to aggregate. By way of example, a keyword and/or voice recognition mechanism(s) can be employed by the analysis component 202 to select data that pertains to a specific topic(s) (e.g., via keyword) or from a specific speaker or group of speakers.

Turning now to the data index component 506, in a collaborative effort, this component can facilitate indexing data from a number of disparate devices. In operation, the index component 506 can work together with the analysis component 202 to extract and/or generate identifying criteria thus enabling the data index component 506 to categorize and/or sort the data in accordance with a desired manner. In one example, the data index component 506 can generate a topical index of the data aggregated via the data compilation component 504.

Referring again to a business meeting scenario, the data index component 506 can, based upon key words or other detection mechanisms, index aggregated data into topics such as, employee issues, financial issues, product issues, or the like. In other words, specific topics discussed during a meeting can be indexed into a specific grouping via the data index component. It will be appreciated that other indexing scenarios exist whereby the aggregated data can be indexed based upon other criteria (e.g., attendees, time, importance/urgency, monetary value). These additional indexing scenarios are to be included within the scope of this disclosure and claims appended hereto.

The memorialize component 508 can be employed in connection with the analysis component 202 to journalize the information. Continuing with the business meeting example, the memorialize component 508 can be employed to generate a journal or record of a meeting. In one example, the record can include “high points” or important discussion aspects of a meeting.

As well, focused journals or records can be established via the memorialize component 508. For instance, separate journals can be provided that are directed to specific groups (e.g., marketing, purchasing, management). In accordance therewith, data can be analyzed and filtered with respect to each of the disparate groups. Keywords can be employed to facilitate filtering of the information. Additionally, another aspect can use the identity of a speaker to determine or infer a categorization.

The video control component 510 and audio control component 512 can be employed to activate and/or deactivate a particular multi-modal device detection. For example, in the business meeting scenario, the video control component 510 (and/or audio control component 512) can be employed to activate a particular multi-modal device integrated camera (and/or microphone) in accordance with a context determined via the analysis component 202.

For instance, in a business conference scenario, the analysis component 202 can be employed together with the video control component 510 and/or audio control component 512 to activate and/or deactivate a camera and/or microphone in accordance with a speaker and/or participant location. In other words, as participants contribute to a discussion, disparate sensors can be activated and/or deactivated to capture information.

Moreover, a translation component 514 can be employed to translate captured information into a language comprehendible to a user. For example, the translation component 514 can be employed to translate captured data into a language comprehendible to a specific listener or audience. This comprehendible language can be determined via a GPS or other location detection system. The GPS or other location detection can be employed to determine a specific location of a user and thereafter, the analysis component 202 can be employed to determine a local language and/or dialect of the detected location and/or region.

As described above, although the aforementioned aspects are directed to a central collaboration component, it is to be understood that each disparate network-connected multi-modal device can include a collaboration component 502. In other words, each multi-modal device can facilitate taking a unique role as part of a combined collaborative document effort. For example, one device can be employed to compile the data from all devices, another device can be employed to index the data and yet another device can be employed to memorialize the data. In this exemplary scenario, still other devices can be employed to capture the data from a specific environment or context.

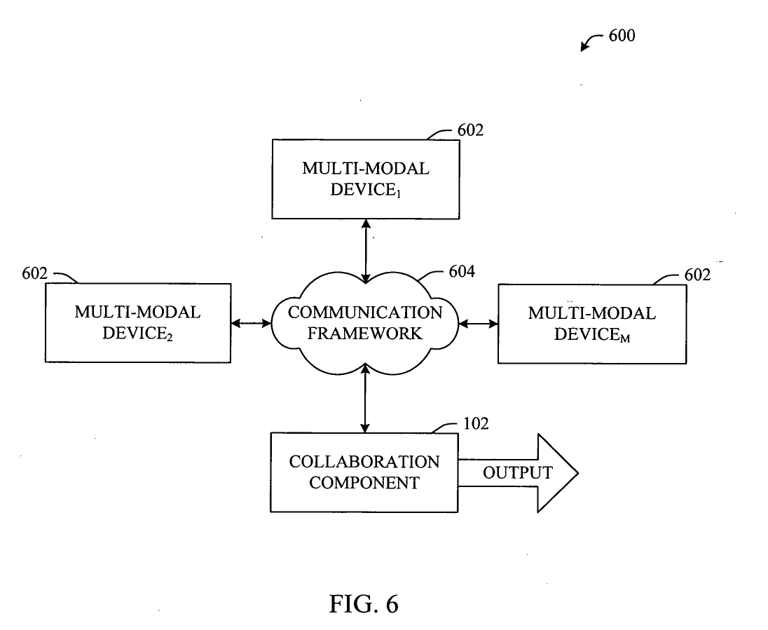

Turning now to FIG. 6, a block architectural diagram of a system 600 that facilitates collaboration of data captured via a network of multi-modal mobile devices is shown. Generally, the system 600 can include 1 to M multi-modal mobile devices, where M is an integer. It is to be understood an appreciated that the 1 to M multi-modal mobile devices can be referred to individually or collectively as multi-modal mobile device 602.

As shown, the multi-modal mobile devices 602 can communicate to each other as well as to a central collaboration component 102 via a communication framework 604 such as a global communications network, for example, the Internet. Accordingly, the collaboration component 102 can be local or remotely located in relation to all or a subset of the multi-modal devices 602.

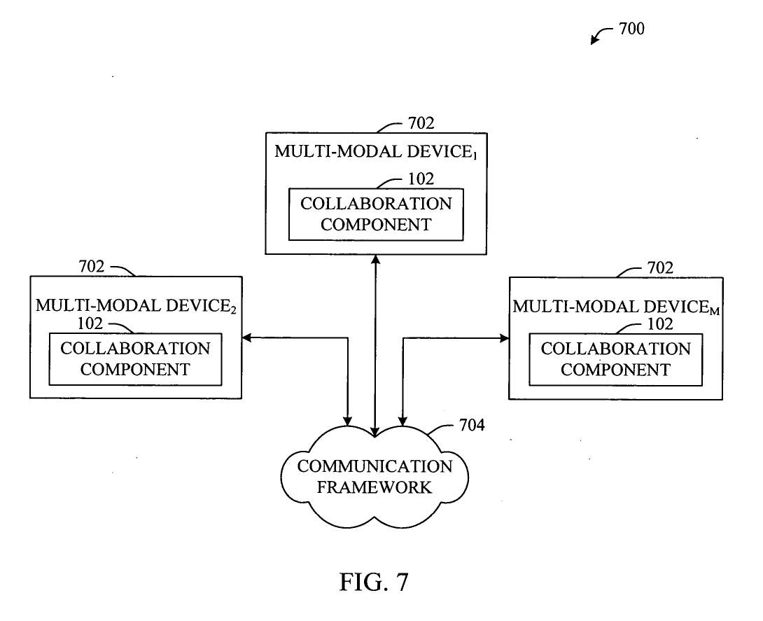

Turning now to FIG. 7, an alternative system 700 that facilitates device and/or data collaboration is shown. As illustrated and as discussed supra, the system 700 can include 1 to M multi-modal devices 702, where M is an integer. In this aspect, each multi-modal device 702 can include a collaboration component 102 that can facilitate collaboration between the individual devices 702. As described above, the collaboration components 102 can facilitate control of (e.g., activation, deactivation) of inputs (e.g., camera, microphone) with respect to a determined context (e.g., state, location, time, attendees).

As shown in FIG. 7, the communication framework 704 can facilitate communication between the disparate multi-modal devices 702 thereby enabling a shared environment for services and data. In accordance with the exemplary system 700, each multi-modal device 702 can communicate with the other multi-modal devices 702 thereby establishing an individual unique role as a part of a combined documentation effort.

For example, each multi-modal device 702 can assume a role as a data collector, an indexer, a note taker, a data consolidator, a memorializing component, etc. Moreover, this decision can be accomplished via a collaborated decision-making process or via a single collaboration component. In either case, each multi-modal device can assume an autonomous role in the information gathering and recording process.

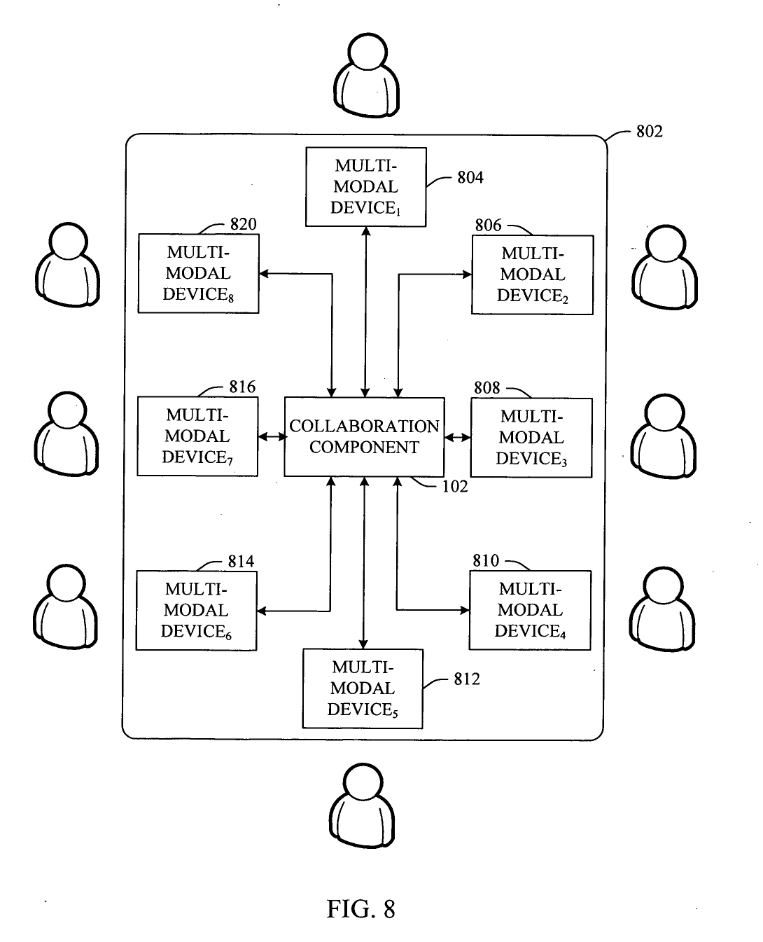

FIG. 8 illustrates a graphical representation of the business meeting example described supra. As shown in the example of FIG. 8, eight individuals can be seated around a conference table 802. Additionally, each individual can place a multi-modal device 804-820 in front of them on the table. In this example, each multi-modal device 804-820 can be equipped with a camera or image capture device. As such, the multi-modal device (804-820) can be placed with the camera facing the individual on the table.

A stand-alone collaboration component 102 can be employed to effectuate a combined collaborative documentation effort with respect to information disclosed at the meeting. As shown, the collaboration component 102 can be physically local or, in alternative aspects, remotely located. In still other aspects, and as discussed above, each multi-modal device 804-820 can include an integral collaboration device.

In operation, and in the configuration illustrated in FIG. 8, the collaboration device 102 can facilitate aggregating, indexing and memorializing data received from each of the multi-modal devices 804-820. In other words, when each of the users speak in a meeting, the collaboration component 120 can activate and/or deactivate sensors (e.g., camera and microphone) thereby optimizing the capture of data by employing a multi-modal device (804-820) that is in close proximity to the speaker.

As shown in FIG. 8, a plurality (e.g., 8) of multi-modal mobile devices (804-820) can be aggregated via the collaboration component 102 to facilitate collaborative data management including, but not limited to, collaborative note taking, presentation generation, memorializing topics discussed or presented in a meeting, etc.

Moreover, as shown in FIG. 8, the multi-modal devices (804-820) can be placed around a conference table 802 thereby generating a dynamic ring camera. In other words, the collaboration component 102 can control each of the cameras integral to the multi-modal devices 804-820. In accordance therewith, the collaboration component 102 can take the role of a producer thereby activating and deactivating camera components in accordance with the context of the environment or meeting. By way of example, as a participant speaks, the collaboration component 102 can automatically and dynamically switch to the appropriate camera in order to capture the content of the participant's message.

As described above, each of the multi-modal devices (804-820) can include an integral collaboration component (not shown) in the place of, or in addition to collaboration component 102, that can enable each of the multi-modal devices 804-820 to take on unique roles respectively as a part of a combined documentation effort. For example, one multi-modal device (e.g., 804) can serve to index received information from the other multi-modal devices (e.g., 806-820).

Additionally, a subset of the devices (e.g., 806, 810, 814, 820) can collect audio and/or visual data, while other devices (e.g., 808, 816) can generate metadata, etc. It will be appreciated that these specific roles are to be considered exemplary and are not intended to limit the invention in any way. Continuing with the example, a single and/or a subset of the multi-modal devices (804-820) can aggregate disparate comments and/or moments into a single temporal based experience.

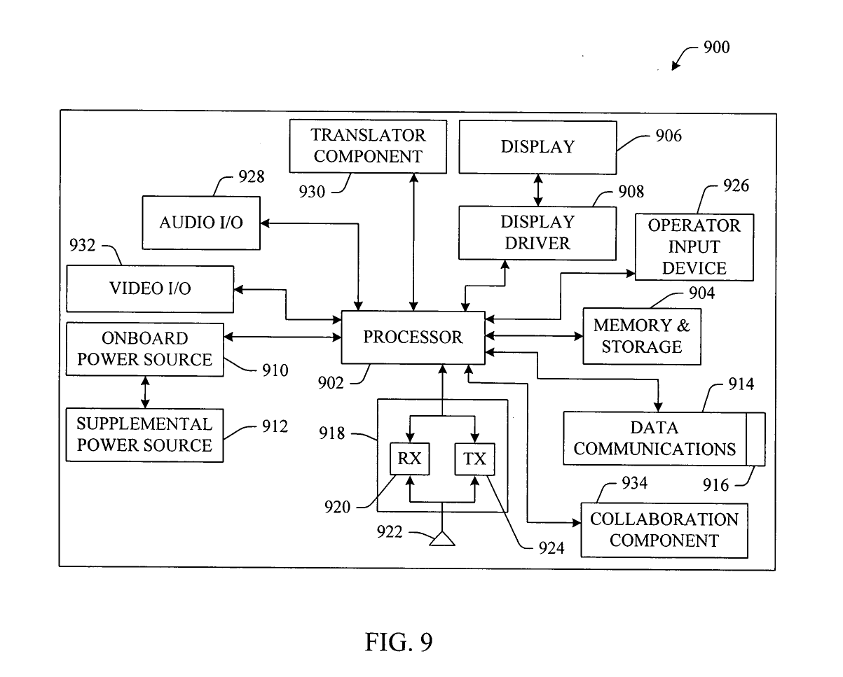

Referring now to FIG. 9, there is illustrated a schematic block diagram of a portable multi-modal multi-lingual hand-held device 900 according to one aspect of the subject invention, in which a processor 902 is responsible for controlling the general operation of the device 900. The processor 902 can be programmed to control and operate the various components within the device 900 in order to carry out the various novel analysis functions described herein. The processor 902 can be any of a plurality of suitable processors. The manner in which the processor 902 can be programmed to carry out the functions relating to the subject invention will be readily apparent to those having ordinary skill in the art based on the description provided herein.

A memory and storage component 904 connected to the processor 902 serves to store program code executed by the processor 902, and also serves as a storage means for storing information such as PIM data, current locations, user/device states or the like. The memory and storage component 904 can be a non-volatile memory suitably adapted to store at least a complete set of the information that is acquired. Thus, the memory 904 can include a RAM or flash memory for high-speed access by the processor 902 and/or a mass storage memory, e.g., a micro drive capable of storing gigabytes of data that comprises text, images, audio, and video content. According to one aspect, the memory 904 has sufficient storage capacity to store multiple sets of information, and the processor 902 could include a program for alternating or cycling between various sets of gathered information.

A display 906 is coupled to the processor 902 via a display driver system 908. The display 906 can be a color liquid crystal display (LCD), plasma display, touch screen display, 3-dimensional (3D) display or the like. In one example, the display 906 is a touch screen display. The display 906 functions to present data, graphics, or other information content. Additionally, the display 906 can render a variety of functions that are user selectable and that control the execution of the device 900. For example, in a touch screen example, the display 906 can render touch selection icons that facilitate user interaction for control and/or configuration. In another aspect, display 906 is a 3D display that can augment and enhance visual qualities thereby making the visuals more true to form. In the case of a remote integration, the display 906 can be employed to display the image selected by the collaborative system as described in greater detail above.

Power can be provided to the processor 902 and other components forming the hand-held device 900 by an onboard power system 910 (e.g., a battery pack or fuel cell). In the event that the power system 910 fails or becomes disconnected from the device 900, a supplemental power source 912 can be employed to provide power to the processor 902 (and other components (e.g., sensors, image capture device, . . . )) and to charge the onboard power system 910, if a chargeable technology. For example, the alternative power source 912 can facilitate an interface to an external grid connection via a power converter (not shown). The processor 902 of the device 900 can induce a sleep mode to reduce the current draw upon detection of an anticipated power failure.

The device 900 includes a communication subsystem 914 that includes a data communication port 916 (e.g., interface component 604 of FIG. 6), which is employed to interface the processor 902 with a remote computer, server, service, or the like. The port 916 can include at least one of Universal Serial Bus (USB) and/or IEEE 1394 serial communications capabilities. Other technologies can also be included, but are not limited to, for example, infrared communication utilizing an infrared data port, Bluetooth™, Wi-Fi, Wi-Max, etc.

The device 900 can also include a radio frequency (RF) transceiver section 918 in operative communication with the processor 902. The RF section 918 includes an RF receiver 920, which receives RF signals from a remote device via an antenna 922 and can demodulate the signal to obtain digital information modulated therein. The RF section 918 also includes an RF transmitter 924 for transmitting information (e.g., data, services) to a remote device, for example, in response to manual user input via a user input (e.g., a keypad, voice activation) 926, or automatically in response to the completion of a location determination or other predetermined and programmed criteria.

The transceiver section 918 can facilitate communication with a transponder system, for example, either passive or active, that is in use with location-based data and/or service provider components. The processor 902 signals (or pulses) the remote transponder system via the transceiver 918, and detects the return signal in order to read the contents of the detected information. In one implementation, the RF section 918 further facilitates telephone communications using the device 900. In furtherance thereof, an audio I/O subsystem 928 is provided and controlled by the processor 902 to process voice input from a microphone (or similar audio input device) and audio output signals (from a speaker or similar audio output device). A translator component 930 can further be provided to enable multi-lingual/multi-language functionality of the device 900.

The device 900 can employ a video I/O subsystem 932 which can be controlled by the processor 902 to process video images from a camera (or other image capture device). Additionally, an optional on-board collaboration component 934 can be provided and can work together with the processor 902 to establish unique roles in a combined documentation effort.

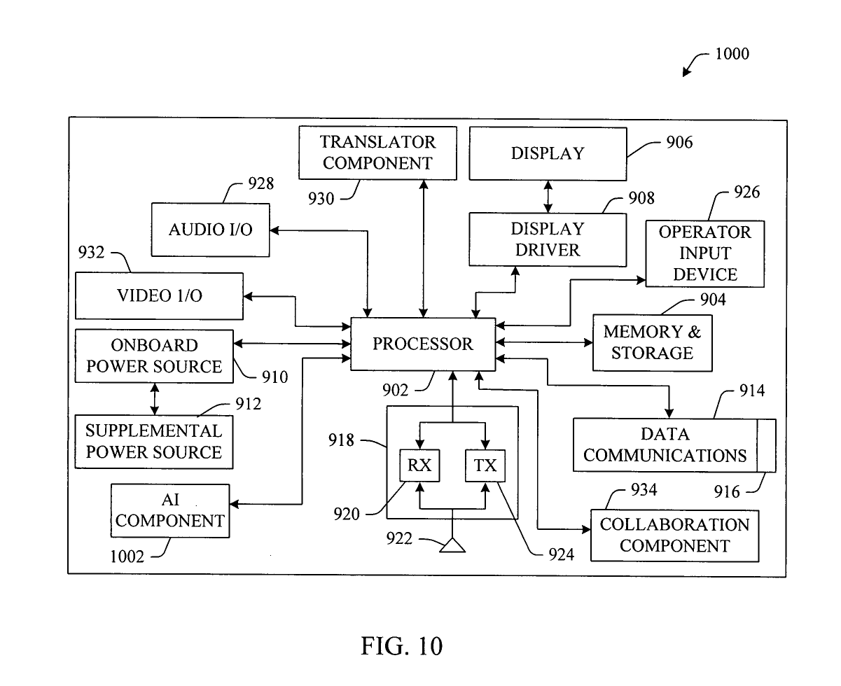

FIG. 10 illustrates a system 1000 that employs artificial intelligence (AI) component 1002 which facilitates automating one or more features in accordance with the subject invention. The subject invention (e.g., with respect to activating a camera/microphone, indexing data, memorializing data, selecting an automated action, . . . ) can employ various Al-based schemes for carrying out various aspects thereof. For example, probabilistic and/or statistical-based analysis can be employed to effect inferring a user intention and/or preference with respect to an indexing and/or data aggregation technique. Additionally, it is to be understood and appreciated that any Al mechanisms and/or reasoning techniques known in the art can be incorporated into the aspects described herein. These additional AI mechanisms and/or reasoning techniques are to be included within the scope of this disclosure and claims appended hereto.

As will be readily appreciated from the subject specification, the subject device 1000 can employ classifiers that are explicitly trained (e.g., via a generic training data) as well as implicitly trained by using methods of reinforcement learning (e.g., via observing user behavior, observing trends, receiving extrinsic information). Thus, the subject invention can be used to automatically learn and perform a number of functions, including but not limited to determining, according to a predetermined criteria, information to gather, when/if to perform an action, which action/device to select, a user preference, etc.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of multi-modal device data collaboration for example, attributes can be words or phrases or other data-specific attributes derived from the words (e.g., database tables, the presence of key terms), and the classes can be categories or areas of interest (e.g., levels of priorities).

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

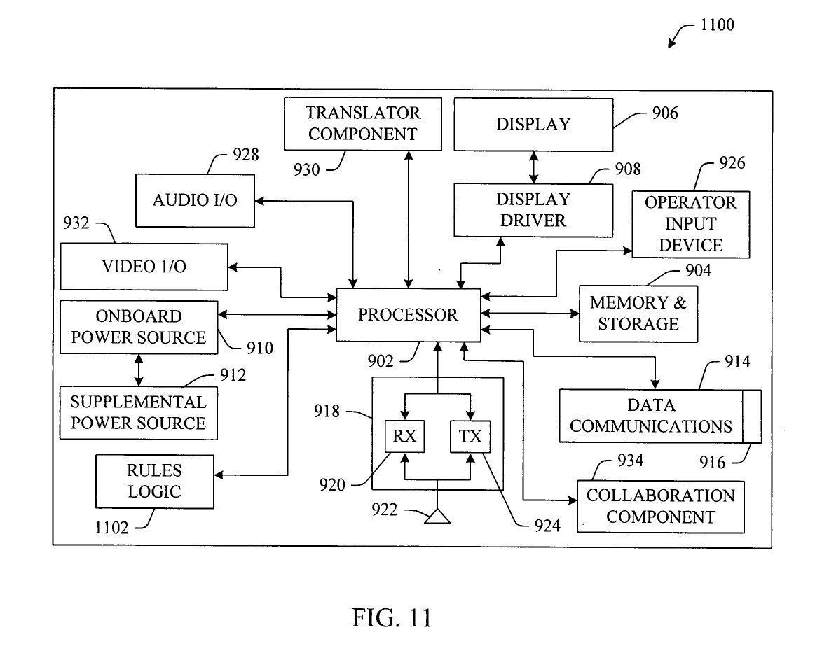

With reference now to FIG. 11, an alternate aspect of the invention is shown. More particularly, handheld device 1100 generally includes a rules-based logic component 1102. In accordance with this alternate aspect, an implementation scheme (e.g., rule) can be applied to define acceptable probabilities, gather information, locate information, determine an action to automate, etc. By way of example, it will be appreciated that the rules-based implementation of FIG. 11 can provide a predetermined indexing scheme in accordance with a user preference. Accordingly, in one aspect, the rules-based implementation can effect filtering, sorting and/or organizing data by employing a predefined and/or programmed rule(s). It is to be appreciated that any of the specifications and/or functionality utilized in accordance with the subject invention can be programmed into a rule-based implementation scheme. It is also to be appreciated that this rules-based logic can be employed in addition to, or in place of, the AI reasoning techniques described with reference to FIG. 10.

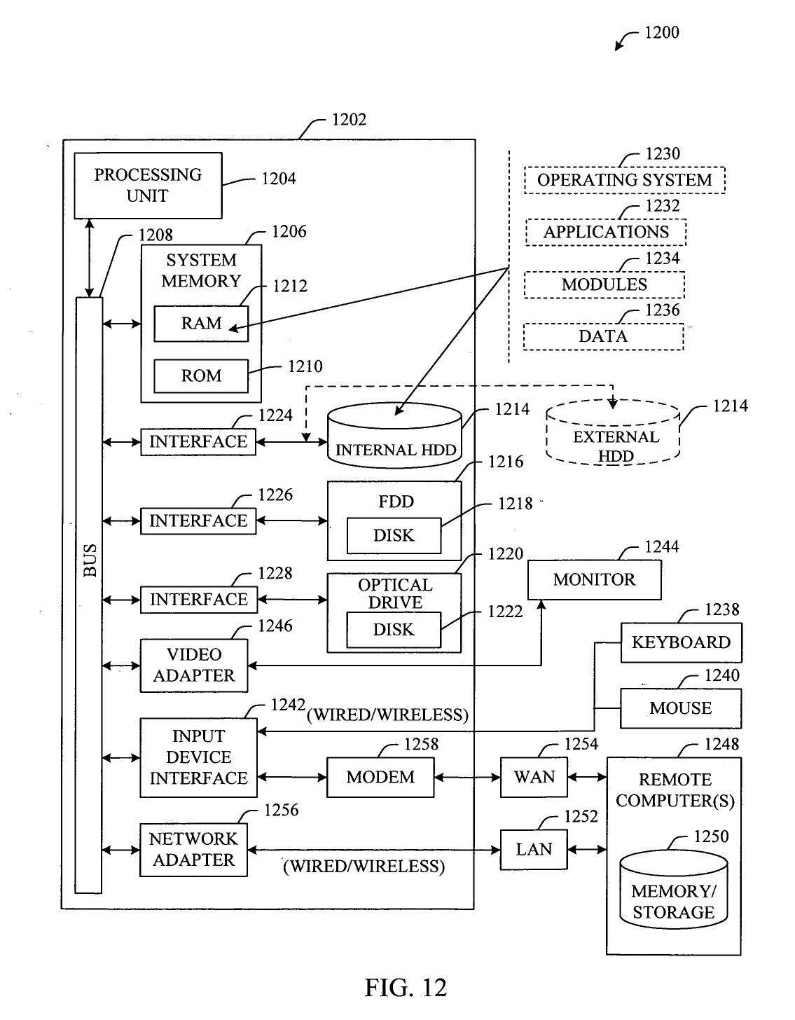

Referring now to FIG. 12, there is illustrated a block diagram of a computer operable to execute the disclosed architecture of collaborating multi-modal devices and data associated therewith. In order to provide additional context for various aspects of the subject innovation, FIG. 12 and the following discussion are intended to provide a brief, general description of a suitable computing environment 1200 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the exemplary environment 1200 for implementing various aspects of the innovation includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the innovation can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

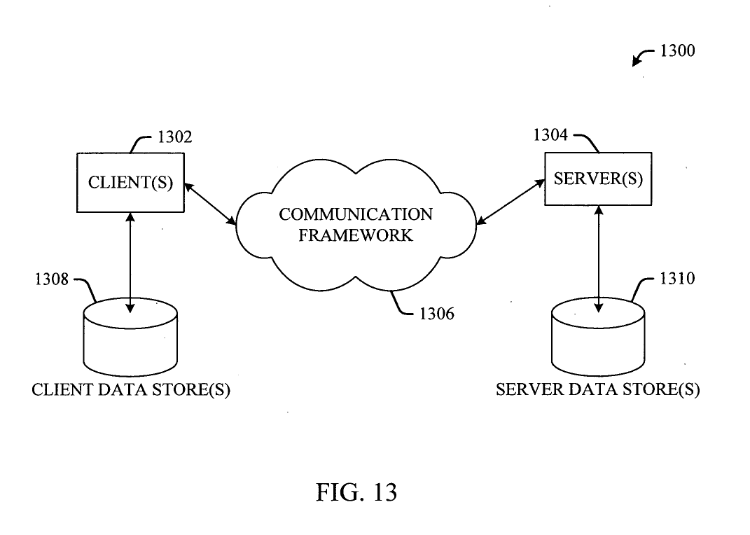

Referring now to FIG. 13, there is illustrated a schematic block diagram of an exemplary computing environment 1300 in accordance with the subject data collaboration system. The system 1300 includes one or more client(s) 1302. The client(s) 1302 can be hardware and/or software (e.g., threads, processes, computing devices). The client(s) 1302 can house cookie(s) and/or associated contextual information by employing the innovation, for example.

The system 1300 also includes one or more server(s) 1304. The server(s) 1304 can also be hardware and/or software (e.g., threads, processes, computing devices). The servers 1304 can house threads to perform transformations by employing the innovation, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates organizing data, comprising:
an interface component that receives data from a plurality of network-connected multi-modal devices; and
a collaboration component that aggregates at least a subset of the data based at least in part upon a context.

2. The system of claim 1, the collaboration component includes an indexing component that categorizes the subset of the data into a defined classification.

3. The system of claim 1, the collaboration component includes a memorialize component that journalizes the subset of the data.

4. The system of claim 1, the collaboration component includes a video control component that activates a video capture device integral to one of the plurality of network-connected multi-modal devices based at least in part upon the context, the video capture device facilitates generation of the data.

5. The system of claim 1, the collaboration component includes an audio control component that activates an audio capture device integral to one of the plurality of network-connected multi-modal devices based at least in part upon the context, the audio capture device facilitates generation of the data.

6. The system of claim 5, the collaboration component further comprises a translation component that translates captured audio data into a language comprehendible to a user.

7. The system of claim 1, the collaboration component facilitates collaborative note generation.

8. The system of claim 1, the collaboration component facilitates collaborative presentation generation.

9. The system of claim 1, each of the plurality of multi-modal devices includes a camera that captures video data and a microphone that captures audio data, the collaboration component dynamically renders the video data and the audio data based at least in part upon the context.

10. The system of claim 1, further comprising an artificial intelligence (Al) component that infers an action that a user desires to be automatically performed based at least in part upon the context.

11. A computer-implemented method of managing data, comprising:
receiving data from a plurality of multi-modal communication devices; and
organizing a subset of the data based at least in part upon a context.

12. The computer-implemented method of claim 1 1, further comprising indexing the subset of the data based at least in part upon the context.

13. The computer-implemented method of claim 11, further comprising journalizing the subset of data, the subset of data represents a plurality of records generated in a meeting between disparate users.

14. The computer-implemented method of claim 11, further comprising:
selecting an image capture device from the plurality of multi-modal devices; and
dynamically capturing an image via the selected image capture device.

15. The computer-implemented method of claim 1 1, further comprising:
capturing an audio stream; and
converting the audio stream into textual data.

16. The computer-implemented method of claim 15, further comprising translating an audio stream into a language comprehendible to a user.

17. The computer-implemented method of claim 1 1, further comprising rendering the data to a remotely located user in real time.

18. A computer-executable system that facilitates data management, comprising:
computer-implemented means for capturing multi-media data associated to an interaction between a plurality of users, the multi-media data includes video data and audio data;
computer-implemented means for aggregating a subset of the captured multi-media data;
computer-implemented means for analyzing the subset of the captured multi-media data; and
computer-implemented means for indexing the subset of the captured multi-media data based at least in part upon a context.

19. The computer-executable system of claim 18, the means for capturing comprises a plurality of multi-modal mobile communication devices each having an image capture device.

20. The computer-executable system of claim 19, further comprising means for automatically controlling each of the image capture devices based upon the context.
